(19) United States
(12) Patent Application Publication
(10) Pub. No.: US 2012/0273576 A1
(43) Pub. Date: Nov. 1, 2012

(54) ARTICLES HAVING MACHINE OR HUMAN READABLE INDICIA IMAGED UNDER A PROTECTIVE LAYER FOR THEFT PREVENTION AND MINIMIZING DAMAGE THERETO, AND METHODS OF MAKING SUCH

(76) Inventors: John Tomczyk, Shoreview, MN (US); Roger H. Ricketts, Apple Valley, MN (US); Terry G. Pabich, Roberts, WI (US)

(21) Appl. No.: 13/271,651

(22) Filed: Oct. 12, 2011

Related U.S. Application Data
(60) Provisional application No. 61/480,213, filed on Apr. 28, 2011.

(51) Int. Cl. G06K 19/02; B41J 2/01

(52) U.S. Cl. 235/488; 347/107

(57) ABSTRACT

A stored value card having increased theft prevention features. A large format sheet having a plurality of cards is imaged with variable indicia. A tamper proof layer is applied over the barcode such that if removed, the variable indicia would no longer be readable. Alternatively, unique human readable indicia is imaged on the substrate and then encapsulated by the tamper proof layer. The sheet is then imaged with a barcode or encoded with a magnetic stripe, simultaneously linking unique human readable indicia to the card. An alphanumeric code matching the unique indicia is displayed at the time of activation to authenticate the card. In either embodiment, the sheet is imaged in large or full format without the need for reducing the size of the sheet.

### RELATED APPLICATION

The present application claims the benefit of U.S. Provisional Application No. 61/480,213 filed Apr. 28, 2011, which is incorporated herein in its entirety by reference.

### FIELD OF THE INVENTION

The invention relates generally to cards, such as transaction cards, stored-value cards, trading cards, loyalty card, or identification/information cards, containing data, information, or graphics in electronic or machine and/or human readable form. More particularly, the invention relates to the protection of data, information, and/or graphics contained on such cards, including, without limitation, fraud prevention, in which one or more of the electronic, machine- and/or human readable indicia related to the data, information, or graphics stored on the card is contained or imaged under a protective and/or tamper proof layer, which in addition provides durable protection of the data from everyday use.

### BACKGROUND OF THE INVENTION

Cards, such as transaction cards (i.e. credit or debit cards, phone cards, calling cards, or gift cards), loyalty cards (i.e. rewards cards, membership cards, key fobs, etc.) identification cards (i.e. drivers' licenses, other government/licensing cards, access cards, business cards, etc.), healthcare cards, membership/association cards, insurance cards, fleet management cards, gaming cards, trading cards and the like can have various pieces of data contained thereon. The data may be contained on or within machine readable indicia, in the form of human readable indicia, or combinations thereof. Examples of machine readable indicia include magnetic stripes, barcodes (including both 1D and 2D), or RFID, for example. These machine readable indicia can be used for account activation, various verification purposes, and/or automated account look-up. Examples of human readable indicia include alphanumeric codes, symbols, or graphics. The machine readable indicia and/or human readable indicia may be correlated with an account, such as, but not limited to a prepaid account, a revolving account against which transactions are conducted, or a bank account such as a checking or savings account. Alternatively, or additionally, the machine readable indicia and/or human readable indicia may be used to identify something or someone.

The perpetration of fraud in the industry of transaction cards, and particularly in the industry of prepaid cards, is an ever increasing and costly problem. One method of fraud perpetration is when the perpetrator takes two cards from a source. Typically, a variable barcode is printed on the surface of the card. The perpetrator removes the barcode from the first card, and then image the barcode from the second card on the first card. The first card with the second card's barcode is then replaced at the source, while the perpetrator retains possession of the second card. When the first card is subsequently activated, it actually activates the second card that is still in the perpetrator's possession such that the second card can be used to conduct transactions, unbeknownst to the holder of the first card.

A second method of fraud perpetration includes a similar method. However, in this case, the information or data stored on a magnetic stripe of the first card is erased, and then encoded with the information or data stored on a magnetic stripe of the second card. The first card is then placed back into the source, and is subsequently activated, thereby activating the second card unbeknownst to the holder of the first card.

One direction that has been taken to prevent or reduce the occurrence of fraud has been the use of packaging assemblies. In one type of packaging assembly, the transaction card and the package, respectively, are separately manufactured from different substrates, and thereafter detachably interconnected in such a way that various data, such as, for example, a personal identification number (“PIN”), on the card is concealed by the package. Other data, also on the card encoded onto a magnetic stripe, or in the form of a barcode, is exposed by the package so that the prepaid account can be activated at the cash register when the packaged card assembly is purchased. See, for example, U.S. Pat. No. 5,760,381 entitled “Prepaid Card” to Stitch et al., and U.S. Pat. No. 5,918,909 entitled “Package for Card with Data-Encoded Strip and Method of Using Same” to Fiala et al., both of which are hereby incorporated by reference in their entireties. One problem with this type of packaged assembly is the combination of the personal or customized indicia and the activation indicia on the same card. Such small cards can easily be stolen from a store by removing the cards from their larger packages, and can then be resold either after illegal activation of the prepaid accounts or after deceiving buyers into believing that the accounts have been activated.

Another type of prior packaged card assembly is one wherein the card and the package have been manufactured jointly from the same substrate, with a perforated or die cut line providing easy detachment of the card from the package. In such case, the personal identifying indicia is on the card in a location concealed by a scratch-off label, for example, while the account activation indicia is on the package in an exposed location for activation of the prepaid account at the cash register. This type of assembly does not encourage a thief to remove the card from the larger package, but produces a card of relatively low durability commensurate with that of the package, and are also susceptible to the barcode and/or magnetic stripe exchange described above. Solutions to this latter problem have been attempted, as exemplified by U.S. Pat. No. 5,650,209 entitled “Manufacture of Telephone Debit Cards” to Ramsburg et al., which is hereby incorporated by reference, wherein the card portion of the common substrate of a card/package combination is laminated in plastic to improve its durability. However the resultant durability does not approach the durability that is obtainable by manufacturing the card separately from the package. Another approach to this problem is exemplified in U.S. Pat. No. 6,543,809 entitled “Simplified Data Package Assembly” to Kistner et al., incorporated herein by reference in its entirety.

When the prepaid account is not of the activatable type, the presence of personal identifying indicia on the card is especially conducive to theft, or unauthorized use of a lost card. For this reason some previous packages, especially those having prepaid debit cards not requiring activation, exclude the personal identifying indicia from the card and instead include such indicia on a separate item concealed within the package. However, this creates a significant manufacturing drawback because of the need to match the card with the separate personal identifying indicia.

Examples of card assemblies can be found in, for example, U.S. Pat. No. 6,224,108 entitled “Packaged Data Card Assembly,” U.S. Pat. No. 6,328,341 entitled “Multiple-Component Data Package,” U.S. Pat. No. 6,439,613 entitled “Multiple-Component Data Package,” and U.S. Pat. No. 6,715,795 entitled “Multiple-Component Data Package,” all to Klure (hereinafter referred to as “the Klure Patents”), and all of which are incorporated herein by reference in their entireties.

Another direction explored to reduce or prevent the occurrence of card fraud is to image a barcode or other machine readable indicia related to the data, information, or graphics stored on the card under a protective and/or tamper proof layer. This is commonly used in the loyalty card industry which comes in the form of a standard transaction card (CR80), one or more key fobs, or combinations of the two.

Loyalty cards and key fobs are currently constructed in one of two ways: (1) laminated Teslin® which is a microporous material available from PPG Industries of Monroeville, Pa.; or (2) traditional card constructions using surface printed, press-polished, or laminated polyvinylchloride (PVC) or styrene. The laminated Teslin® has the distinct advantage over the traditional card constructions because personalized information, such as barcodes, PINs, or other indicia, is buried and protected under the laminate film making it less conducive to theft, and degradation of the indicia. For example, key fobs placed on and used from a keychain can get damaged from transport in a purse or pocket. The personalized indicia, being positioned under the protective laminate, is not degraded by such wear and tear.

If the cards are of substantial card quantity, such as one million or more, the traditional card construction, currently the single most economical way to add personalized or variable data to a card via printing (“imaging”), e.g. in the form of a printed barcode, is to use drop on demand inkjet printing. Personalized or variable data is data that is unique to the particular card, such that the data changes from card to card in a production run. However, with traditionally manufactured cards, this personalized data or indicia is imaged on the surface of the card or key fob, and has a propensity to rub or scratch-off over time, rendering the indicia unreadable or unscannable. A clear protective label can be applied over the indicia to improve degradation; however, the application of a label is perceived as an aesthetic degradation than a smooth-backed card.

A drawback of the laminated Teslin® construction is that the digital devices currently available that can do variable imaging are limited to a sheet size of up to 13″×20″. This requires an additional process step or run time to traditional card manufacturing because the sheets must be either cut down before imaging to an acceptable sheet size, or more sheets must be run to produce the same amount of cards. Furthermore, the digital devices currently available are limited to a maximum thickness of up to 16 mil, which is about one-half of the thickness required to meet ISO 7810 Specification of 30 mil plus or minus 10%, incorporated herein by reference in its entirety. This requires the addition of layers after imaging to add thickness. In addition, a 30 mil Teslin® construction, for example Teslin® core with two layers of polyester laminate, usually costs more than a traditional 30-mil card construction, for example a PVC or styrene core with a thin PVC, polyethylene, or polyester laminate.

Particularly, the variable imaging of the Teslin® construction described above can currently be done on a variety of devices, such as, for example, Xeikon (a digital web press that prints 2-sides), Xerox, MGI, or other toner devices, or on an Indigo sheet fed press available from Hewlett-Packard. Other printing methodologies can include dye sublimation which is a slow expensive process because only one card at a time can be imaged, laser which never really black but rather looks grey, thermal toner transfer, and emboss imaging, both of which are slow expensive processes because only one card at a time can be imaged.

The sheets are printed with graphics, text, and other visual elements before imaging. For example, they are printed in full or large format, such as 26″×40″ converted to smaller format (13″×20″), and then imaged with the variable data. Otherwise, smaller sheets are printed and imaged, requiring more sheets to be run, than in a large format process. The sheets are then inserted into a two sided laminator, where a polyester thermal laminate film is applied to two sides, such that the overall construction of polyester/Teslin®/polyester is about 30 mils thick, each layer of polyester being about 10 mils thick. The sheets are then directly run into a rotary or platen die cut system, where they are converted to the desired finished size, such as, for example, a CR80 card or a key fob or combination.

Another drawback of the Teslin® construction is that a barcode print quality is significantly diminished from traditional card constructions. As background, barcodes encode data in much the same way that Morse Code works, using a series of wide and narrow bars and spaces instead of dots and dashes to encode each character. The widths of the bars and spaces are critical. If the widths are wrong, the barcode can be unreadable or can be decoded improperly. Barcode readers or scanners need to be able to tell the difference between a bar and a space. If the contrast between them is not great enough, the barcode may not be readable.

Barcodes have “quiet zones” on either side of the symbol. Quiet zones are blank areas, free of any printing, typically ten times the width of the narrowest bar or space in the barcode. Failure to allow adequate space on either side of the symbol for quiet zones can make it impossible to read the barcode.

American National Standards Institute has published a barcode print quality specification named ANSI X3.182. This specification uses a number of categories of measurement criteria to grade barcode print quality using letter grades ranging from A to F in which a score of 3.5-4.0 is designated as an “A”, 2.5-3.4 is a “B”, 1.5-2.4 is a “C”, 0.5-1.4 is a “D”, and 0.0-0.4 is an “F”. Although any barcode having a grade better other than an “F” is considered passing, the better the grade means that the barcode is more readily scannable or properly readable, thereby saving time at a point of use, such as, for example, at a cash register. Barcode print quality has become such an important issue that some retailers have resorted to fines or “charge backs” for out-of-specification bar codes.

The ANSI print quality grading method is based on the relationship between the printed symbol and the way barcode scanners interpret the symbol. In order to determine how well a bar code will perform in typical situations, a number of measurements are performed by a barcode verifier to determine the final grade of the symbol.

The first key measurement is decode. This is a test to decipher the bars and spaces into meaningful data. Assuming that the decode test passes, the other checks are graded from A through F. If the symbol cannot be decoded, it fails and automatically receives a grade of F. Other measurements include:
Decodability which is a measurement that tests the printing accuracy of the symbol. In general, the higher level of decodability, the better a scanner can be expected to perform.
Symbol contrast which is a measurement between the largest and smallest reflectances in a scan profile. In general, the lighter the spaces and darker the bars, the better the symbol contrast. Colored symbols are acceptable if they provide adequate contrast.
Modulation which is a ratio of the minimum edge contrast to the symbol contrast. This test looks at the edges of the bars and compares them to the clarity of the spaces and also looks at the edges to be sure that they are not wavy or fuzzy. It also grades the extent to which narrower bars and spaces are visible to the scanner and verifier.
Defects which are irregularities found within bar elements and quiet zones. Most often these are spots (dark blots in the middle of a light space) or voids (light blots in the middle of a dark bar) in the symbol.
Reflectance which a measure of the amount of light reflected from an illuminated source. Light is reflected from the spaces and absorbed by the bars and this measurement checks the spaces and quiet zones to be sure that ample light is being reflected so that a scanner can pick up the bar and space elements in a bar code.

Other factors can also contribute to the determination of how a symbol is graded such as label material opacity, surface gloss measurement, and the effect of over-laminates. Regarding over-laminates, the quality of the barcode print can be degraded during the lamination process, particularly if heat and/or pressure are used. Other considerations can include the thickness of the over-laminate and the opacity of the over-laminate. For example, the thicker the over-laminate, the greater the risk that the light of the scanner or verifier is diffracted, making the barcode unreadable. Similarly, if the over-laminate is not optically clear, the light of the scanner or verifier can be diffracted, making the barcode unreadable.

The currently-used Teslin® construction typically does not have a barcode print quality better than an “F” or “D”. This can be caused by any of a number of factors or combinations thereof, including the microporisity of the Teslin® such that the printed barcode is wavy or inconsistent, the thicker laminate needed to meet ISO specifications for transaction cards for overall thickness, the degradation of the print quality during lamination due to heat and/or pressure, and printing limitations of the imaging head capable of printing Teslin® material. There remains a need for an imaged article having imaging under a laminate that results in a higher print quality. Furthermore, as described above, the digital print method is effective for shorter runs, but is much more costly for larger runs. Therefore, there remains a need for a method of imaging a larger sheet size for running larger sheet sizes. Finally, there remains a need for a card containing static and/or personalized or variable data that can be efficiently and economically produced, while providing sufficient protection of the data to reduce damage to the data and to prevent or reduce the perpetration of card fraud.

### SUMMARY OF THE INVENTION

Embodiments of the invention are directed to a card, such as a transaction card, identification card, loyalty card, key fob, or trading card, with increased fraud prevention characteristics, and can be economically and efficiently produced. The cards are manufactured in full sheet, single core format, such as 28″×36¾″ or larger, such that the sheet can be both printed and imaged with a plurality of static and/or unique variable indicia without the need for converting the full sheet to smaller sheets or individual cards before imaging, thereby reducing at least one process step. Once the sheet is printed and imaged, the sheet is laminated on one or both sides with a thin over-laminate, such as a laminate of about one to about four mils, covering the printed or imaged indicia. It is then converted or cut into a plurality of individual cards, each having imaged variable indicia or data thereon. An optional magnetic stripe is applied, either before or after converting, onto or embedded within the outer surface of over-laminate material on one or both sides of the card. The finished sheets can have a thickness of about 10 to about 50 mils, particularly from about 22 to about 40 mils, and more particularly about 30 mils plus or minus ten percent such that the card meets ISO transaction card standards for thickness.

In one embodiment of the invention, one or more variable or non-variable machine readable indicia, such as a barcode, is imaged under a protective laminate such that the indicia cannot be easily removed from the card without destroying the card, i.e. it is tamper evident or tamper proof. In the case of a barcode, the barcode has a print quality of “C” or better according to ANSI X3.182 described above.

In another embodiment of the invention, unique or non-unique human readable indicia, such as that correlated to an account, such as a variable number associated with the account on the card, is imaged under the protective laminate in manufacturing of the card, as opposed to a label over the indicia as described in the Background section. The card is either subsequently imaged with a barcode and/or the magnetic stripe is encoded, the unique number is read with a camera, thereby linking the unique number to the card with the particular barcode and/or encoded magnetic stripe on it. Upon subsequent purchase and activation of the card at a register in a retail environment via the barcode or magnetic stripe, the register's computer system displays the unique number associated with the barcode or magnetic stripe, and the cashier verifies that the unique number printed under the laminate matches the unique number on the computer system. A failure in matching the numbers can be indicative of fraud, which alerts the cashier or merchant not to activate that particular card.

In yet another embodiment of the invention, a lens sheet can be placed over a printed substrate. The lens sheet includes one or more lens arrays in pre-selected areas of a first surface of the lens sheet. A barcode can be imaged on an opposing, generally planar side of the lens sheet on an area that is not under a lens array such that the barcode is viewable through a flat or planar portion of the first surface of the lens. The lens sheet is then bonded or married to a backer sheet or laminate, sandwiching the barcode therebetween. Alternatively, the barcode can be imaged on a backer sheet that is married to the lens sheet such that the barcode is sandwiched between the lens sheet and the backer sheet, and viewable through a flat or planar portion of the first surface of the lens.

In yet another embodiment of the invention, one or more print heads can be placed down-web or down-line from the drop-on-demand (DOD) barcode imaging lines in a card manufacturing process. After a card, sheet, or web of cards are imaged with one or more unique barcodes, the one or more print heads selectively apply a clear, permanent, tamper evident material, such as a hard coating, over at least the barcode portions of the card or sheet. Optionally, the coating can incorporate a marker, which can be detected by a UV light pen or other detection device to ensure its authenticity, i.e. that the original barcode is associated with the card.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a cross-sectional view of an imaged sheet according to an embodiment of the invention.

FIG. 2 is a cross sectional view of an imaged sheet according to another embodiment of the invention.

FIG. 3 is a cross sectional view of an imaged sheet according to yet another embodiment of the invention.

FIG. 4 is a system for producing an imaged sheet according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE DRAWINGS

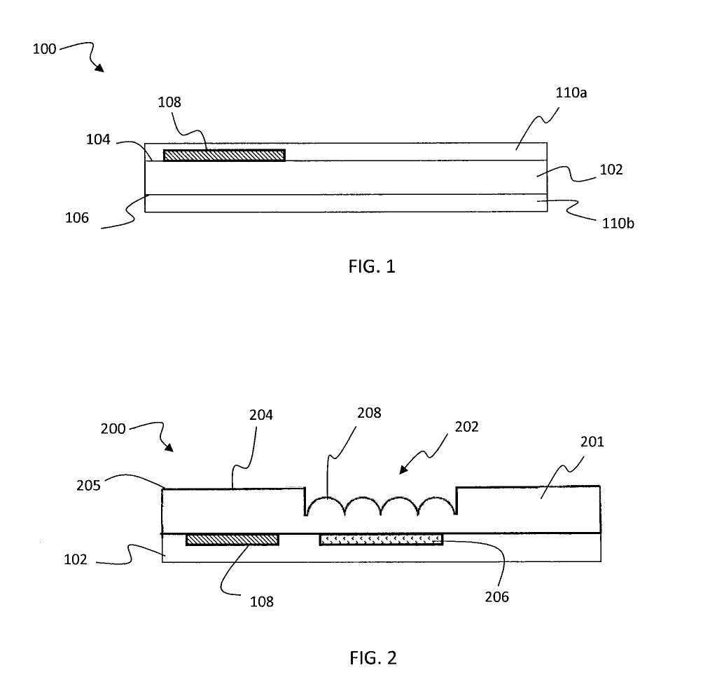

Referring to FIG. 1, a sheet 100 comprises a substrate 102 having a first surface 104 and a second surface 106. Substrate 102 can comprise any of a variety of substrates including plastic, paper, paperboard, cardboard, metal, foil, and/or combinations thereof. In one particular embodiment, substrate 102 comprises a polymeric material such as, for example, polyvinyl chloride (PVC), polyethylene terephthalate (PETG), polylactic acid (PLA), polypropylene, polystyrene (HIPS) polyethylene, or combinations thereof. Substrate 102 can comprise single card or a large or full sheet format (for example, 28″×40″ sheets) for containing a plurality of articles, such as a plurality of stored data cards, key fobs, or combinations thereof. Substrate 102 can comprise a single layer or “single core,” or multiple layers adhered together or “split core.” Substrate 102 comprises a first surface 104 and a second surface 106.

At least one machine and/or human readable indicia 108 is deposited on first surface 104 and/or second surface 106 of substrate 102. Indicia 108 can comprise, for example, a contactless feature such as, for example, a barcode that can be scanned by an appropriate scanner to access specific information or data stored thereon, a human-readable alphanumeric code, a 2D barcode such as a QR code or matrix code type, a multiple bar code layout, or a stacked bar code type, a Microsoft tag, or any of a variety of human or machine readable indicia. Machine and/or human readable indicia 108 can be used for account identification, account activation, automated account look-up, and/or to conduct transactions against a user's account correlated to the data encoded in machine and/or human readable indicia 108. Alternatively, it could be used to validate the identity of an individual, or grant access to otherwise secured information or media or locations. Indicia 108 can be used for any number of purposes, the description herein not intending to limit the use of Indicia 108, but merely examples of possible uses.

Machine and/or human readable indicia 108 can be applied to substrate 102 by a variety of means, including as a label, or more preferably by imaging using high resolution printing techniques, and more particular computer-controlled digital-printing techniques such as, for example, laser imaging, ink jet including drop-on-demand (DOD) and continuous inkjet, thermal imaging, and/or xerographic imaging. In one particular embodiment of the invention machine and/or human readable indicia 108 comprises a barcode deposited on first surface 104 of substrate 102 using DOD printing with black, colored, or black light UV-curable inks. The DOD print head is suitable to produce a barcode having a print quality grade of “C” or better per ANSI X3.182 described above.

A protective layer 110, such as a tamper evident and/or tamper proof layer is deposited over at least a portion of first surface 104 and/or second surface 106 containing machine and/or human readable indicia 108 to completely encapsulate machine and/or human readable indicia 108. In one embodiment, protective layers 110a, 110b are sufficient to form a destructible bond such that if it was breached, either tamper proof layer (e.g. laminate material) would be destroyed without possibility to replace without evidence of tampering, or machine and/or human readable indicia 108 would be destroyed, i.e. it would no longer be machine readable or legible. In one embodiment, protective layer 110 is sufficiently transparent such that visual scanning devices, such as a scanner, can transmit light through and read machine and/or human readable indicia 108. In another embodiment, protective layer 110 sufficiently transmits wavelengths outside of the visual spectrum, such as UV or IR, from a reading device to read machine and/or human readable indicia 108.

In one embodiment of the invention, protective layer 110 comprises a laminate such as, for example, a poly-laminate having an adhesive layer thereon. The laminate can comprise PVC, polyethylene, polypropylene, or any of a variety of suitable laminates with or without adhesive. The laminate can be bonded to substrate 102 using lamination techniques known to one of ordinary skill in the art, such as compression lamination, nip rolling, and the like. The lamination technique should be chosen so as not to significantly distort or destroy machine readable indicia. In one particular embodiment, in which machine and/or human readable indicia 108 comprises a barcode deposited on first surface 104 of substrate 102 using DOD printing with black, colored, or black light UV-curable inks, the barcode retains its print quality grade of “C” or better per ANSI X3.182 after lamination.

In another embodiment of the invention, and referring to FIG. 2, sheet 200 includes a protective layer comprising a lens sheet 201 having a lens array 202 and one or more flat or planar portions 204 on a first surface 205 of lens array 202. Machine and/or human readable indicia 108 is positioned under planar portion 204 such that it is viewable and/or readable through planar portion 204, and is sandwiched between substrate 102 and lens sheet 201. In one embodiment, machine and/or human readable indicia 108 is imaged on lens sheet 201, and in an alternative embodiment, machine and/or human readable indicia 108 is imaged on substrate 102.

Optionally, a special effect image 206 can be printed under lens array 202. Special effect image 206 is viewable through lens array 202, such that lens array 202 imparts visual effects on image 206 including three-dimensionality, and/or animation or motion. Lenses 208 can extend above a first surface of lens sheet 201, or can be set below lens sheet 201, as shown, and as described in U.S. Provisional Application No. 61/420,571, and U.S. patent application Ser. No. 13/229,116, both entitled “Lens Sheet Having Lens Array Formed in Pre-selected Areas and Articles Formed Therefrom,” both of which are incorporated herein by reference in their entireties. Alternatively, lens sheet 201 may not have a planar portion 204, and instead comprise only lens array 202.

In yet another embodiment of the invention (not shown), the protective layer comprises a transparent coating material, such as a radiation or heat curable coating. A coating head can be placed in-line after the DOD imaging station such that the transparent coating is applied after the substrate is imaged with the machine readable indicia. Curing stations can also be inline to cure the coating upon application. Example coatings can include radiation curable coatings such as UV-curable, IR-curable, or e-beam curable coatings, or heat-curable coatings. An example of a device for producing a coating on printed products from a printing press is described in U.S. Pat. No. 7,451,698 to Schneider et al., which is herein incorporated by reference in its entirety. In one particular embodiment, in which machine and/or human readable indicia 108 comprises a barcode deposited on first surface 104 of substrate 102 using DOD printing with black, colored, or black light UV-curable inks, the barcode retains its print quality grade of “C” or better per ANSI X3.182 after lamination.

In a specific example, a sheet substrate comprising a 28″×40″ 26 mil white opaque polyvinyl chloride material of gloss/matte finish is imaged with a barcode on a first gloss surface using a DOD imaging line capable of imaging a large sheet format and capable of producing a print quality grade of “C” or better per ANSI X3.182, and black UV-curable ink at a frequency of one or more barcodes per card. Optionally, a variable alphanumeric code, such as a PIN can be printed inline with the barcode using colored or black UV-curable ink. Additional graphics and text printing, either variable or static, is applied to both the front and back of the substrate either before the DOD imaging line or printed with the DOD imaging line. The sheets are then compression laminated over the surface having the barcode. The laminate comprises a 1.8 mil bleed PVC film for some sheets, and a 1.8 mil PVC over-lamination film for others, wherein the bleed film includes an adhesive, while the over-lamination film does not. Once laminated, each sheet is converted into a plurality of cards by punching or cutting, each card having its unique barcode imaged thereon. The barcode retains its print quality grade of “C” or better per ANSI X3.182. An optional scratch off coating or label with a scratch off coating can be applied over the PIN either before or after cutting into final card size. Cards can be cut by any of a variety of methods, including, but not limited to, a male/female punch die, a PMC (Printing Machinery Corp.) or high die, steel rule die cut, a digital cutting table, or laser.

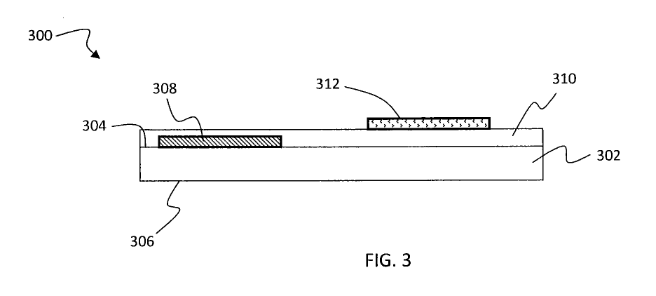

In an alternative embodiment of the invention, and referring to FIG. 3, a sheet 300 comprises a substrate 302 having a first surface 304 and a second surface 306. Substrate 302 can comprise any of a variety of substrates including plastic, paper, paperboard, cardboard, metal, foil, and/or combinations thereof. In one particular embodiment, substrate 302 comprises a polymeric material such as, for example, polyvinyl chloride (PVC), polyethylene terephthalate (PETG), polylactic acid (PLA), polypropylene, polyethylene, high integrity polystyrene (HIPS), or combinations thereof. Substrate 302 can comprise single card or a large sheet format (for example, 28″×40″ sheets) for containing a plurality of articles, such as a plurality of stored data cards, posters, postcards, game piece, or other articles.

At least one variable or non-variable human readable indicia 308 is deposited on first surface 304 and/or second surface 306. Human readable indicia 308 can comprise, for example, a personal identification number (PIN) or other unique variable or non-variable number or alphanumeric code that is correlated to an account associated with the card. Human readable indicia 308 can be applied to substrate 302 by a variety of means, including as a label, or more preferably by imaging using high resolution digital printing techniques, and more particular computer-controlled digital printing techniques such as, for example, laser imaging, ink jet including drop-on-demand (DOD) and continuous inkjet, thermal imaging, and/or xerographic imaging such that the human readable indicia 308 can be unique for every card.

A protective layer 310, such as a tamper evident and/or tamper proof layer, is deposited over at least a portion of the surface containing human readable indicia 308 to completely encapsulate human readable indicia 308. In one embodiment, protective layer 310 is sufficient to form a destructible bond such that if it was breached, human readable indicia 308 would be destroyed, i.e. it would no longer be readable or legible, or it would be clear that indicia 308 was no longer covered/protected, or sealed.

In one embodiment of the invention, protective layer 310 comprises a laminate such as, for example, a poly-laminate having an optional adhesive layer thereon, as described above. The laminate can be bonded to substrate 302 using lamination techniques known to one of ordinary skill in the art, such as compression lamination, nip rolling, and the like. The lamination technique should be chosen so as not to distort or destroy human readable indicia 308.

In yet another embodiment of the invention (not shown), the protective layer comprises a transparent coating material, such as a radiation or heat curable coating. A coating head can be placed in-line after the DOD imaging station such that the transparent coating is applied after the substrate is imaged with the human readable indicia. Curing stations can also be inline to cure the coating upon application. Example coatings can include radiation curable coatings such as UV-curable, IR-curable, or e-beam curable coatings, or heat-curable coatings. An example of a device for producing a coating on printed products from a printing press is described in U.S. Pat. No. 7,451,698 to Schneider et al., which is herein incorporated by reference in its entirety.

Referring back to FIG. 3, a machine readable indicia 312, such as a magnetic stripe or a barcode, is positioned on the top side of protective layer 310 and/or on second surface 306 by imaging techniques described above, such as DOD imaging of barcodes. In one embodiment of the invention, one or more magnetic stripes can be applied to protective layer 310 and/or second surface 306 pursuant to U.S. Pat. No. 6,481,994 entitled “Apparatus for Making a Magnetically Readable Card,” U.S. Pat. No. 6,964,810 entitled “Magnetically Readable Card and a Method of Making a Magnetically Readable Card,” and U.S. Pat. No. 7,300,535 entitled “Magnetically Readable Card and a Method of Making a Magnetically Readable Card,”, all of which are incorporated herein in their entirety. Alternatively, machine readable indicia 312 may be applied via other techniques known to the industry.

Upon deposition of machine readable indicia 312, such as imaging of a barcode and/or encoding of a magnetic stripe on each card in a sheet of cards, a camera is placed in-line to read and record human readable indicia 308 such that human readable indicia 308 is linked or otherwise correlated to the particular card with machine readable indicia 312 thereon. In one embodiment of the invention, human readable indicia 308 is read, and corresponding machine readable indicia is found in the database. This corresponding machine readable indicia 312 is then applied to the card. In another embodiment of the invention, machine readable indicia 312 is applied to the card. Human readable indicia 308 on the same card is then read, and the two are linked in the database.

Upon activation of the card in a retail environment via machine readable indicia 312, a variable alphanumeric code is displayed to the cashier or other individual activating the card. If the alphanumeric code matches human readable indicia 308 displayed on the card, it authenticates the card, indicating that no theft or fraud to the card has occurred. If it does not match, the individual does not confirm activation of the card, as it alerts the cashier that the card may have been tampered with or the data on the card stolen.

In any or all of the embodiments, the substrate and/or protective layer can be imaged, such as by printing, embossing, and the like, with any of a variety of human readable or machine readable indicia. Human readable indicia can include, for example, alphanumeric text, graphics, patterns, color layers, foil, PIN numbers, scratch-off layers, and/or combinations thereof. Machine readable indicia can include for example, magnetic stripes, additional bar codes, RFID, and the like. The additional imaging can be accomplished by any suitable technique, such as printing techniques, either inline with the barcode imaging, or in a separate process.

In a specific example, a sheet substrate comprising a 28″×40″ 26 mil white opaque polyvinyl chloride material having a gloss/matte finish is imaged with unique human readable indicia, such as a PIN, on a first surface using a DOD imaging line and black UV-curable ink at a frequency of one unique human readable indicia per card. Additional graphics and text printing is applied to both the front and back of the substrate either before the DOD imaging line or printed with the DOD imaging line. The sheets are then compression laminated over the surface having the unique human readable indicia. The laminate comprises a 1.8 mil bleed PVC film for any side of sheets that have heavy ink coverage as the bleed film includes an adhesive, and a 1.8 mil PVC over-lamination film for any side of sheets with non-heavy or lighter ink coverage. Once laminated, the sheets are imaged with a barcode on a DOD line, and/or encoded with a magnetic stripe on an encoding line, at a frequency of one or more per card. At the time of imaging or encoding, the unique human readable indicia is read via camera such that the unique human readable indicia of each card is linked or correlated with the data stored in the barcode or magnetic stripe. Alternatively, if the barcode is imaged with a DOD line prior to applying the over-laminate, the human readable indicia is read, and the human readable indicia and machine readable indicia are linked in a database.

Each sheet is then converted or cut into a plurality of cards by punching or cutting. An optional scratch off coating or label can be applied over the PIN either before or after cutting as described above.

There is an added benefit in addition to the optional security features described supra. Although there is no specific ISO specification for the level of protection against abuse, wear, or degradation, the over-laminate or coating protects both the variable and non-variable ink layers under the laminate from degradation caused by processing and/or normal wear for a transaction, identification, or other type of card having variable data thereon.

For example, the over-laminate or coating protects the variable printed machine or human readable information from the DOD image under laminate machine during processing. Furthermore, the over-laminate or coating protects both variable and non-variable printed ink layers, including machine printed variable information, human readable information, and static information, from normal wear and degradation that such cards may be subject to. This normal wear can include degradation caused by repeated removal and insertion from a wallet, purse, or pocket, from multiple swipes through a magnetic stripe reader, and/or from loose change or keys or other objects rubbing against the surface of the card or key fob.

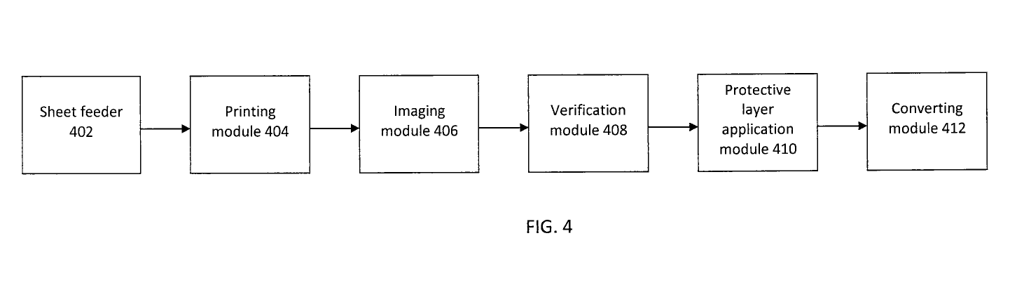

Now referring to FIG. 4, a system 400 for producing articles having machine-readable indicia under a protective layer includes a sheet feeder 402, a printing module 404, an imaging module 406, an optional verification module 408, a protective layer application module 410, and a converting module 412. Sheet feeder 402 can be any of a variety of suitable sheet feeder to supply sheets of substrate material described above onto a conveyor system such as a conveyor belt. In one embodiment of the invention, the sheet of substrate material is in large format, i.e. it is approximately 28″×36¾″ to about 28″×40″, and at least 20 to about 40 mils thick, and more particularly about 25 to about 30 mils thick. In one embodiment, the substrate is single core. In an alternative embodiment, the substrate is multi-core, i.e. two or more sheets laminated together.

The sheets are individually fed from sheet feeder 402 to printing module 404. Printing module 404 prints any of a variety of static and/or variable indicia on one or both sides of the substrate. Such indicia can include text, graphics, images, customer information, foils, special imaging indicia such as interlaced images and the like, or any of a variety of indicia and/or embellishments. The printing can be accomplished using contact or contact-less methods including, but not limited to flexography, lithography, laser, thermal, inkjet, drop-on-demand, xerography, screen printing, gravure, rotogravure, or combinations thereof. A corresponding suitable ink, toner, or other printing medium is used depending the type(s) of printing methods including UV or radiation curable inks or toners, e-beam curable mediums, heat or IR curable, or combinations thereof. Printing module 404 can comprise optional corresponding curing stations to cure the printing medium as needed. Printing module 404 can also comprise an optional pretreatment station prior to printing. Such pretreatments can include corona treatment, flame treatment, application of a primer, or other treatments such that the surface of the substrate is modified to better bond with the printing medium.

Imaging module 406 can be positioned before and/or after printing module 404. Imaging module 406 can comprise any suitable printing head for imaging a machine- and/or human-readable indicia on one or both of the substrate. In one embodiment, the indicia comprise barcodes, and imaging module 406 comprises one or more DOD imaging heads. In a particular embodiment, imaging module 406 comprises an array of ten imaging heads, each having an imaging width of about 70.5 mm, such that each imaging head prints a barcode using colored or black UV-curable ink at a location along the width of the sheet, and at the same position along the width at multiple positions along length of the sheet. Such heads are available from Xaar, for example. Imaging module 406 further comprises one or more suitable curing stations for curing the imaged indicia corresponding to the type of medium used for imaging.

In one embodiment of the invention, the one or more print heads are adapted to accommodate distortion of the barcode during subsequent processing, such as lamination. For example, the print head(s) are programmed to print the barcode larger than the final desired barcode to accommodate for shrinkage of the substrate during lamination using heat and/or pressure. The barcode is graded before and after lamination.

System 400 can also optionally include verification module 408 comprising one or more cameras, scanners, or verifiers. In one embodiment, the indicia comprises barcodes, and verification module 408 comprises one or more scanners and/or verifiers to determine whether the barcode is readable, and optionally assigns a grade per ANSI X3.182. If one or more of the barcodes on the sheet fail to scan or do not receive a grade of “C” or better, the sheet is discarded at that point. In another embodiment, the indicia comprise human-readable alphanumeric codes, and verification module 408 comprises one or more cameras for matching the codes to machine-readable indicia located on the substrate, as described above.

Protective layer application module 410 can comprise any of a variety of laminators such as nip rollers or compression laminators for applying a laminate to one or both sides of the substrate to cover the indicia, or can comprise one or more coating stations such as print heads, curtain coaters, screen coaters, or the like for applying a coating over one or both sides of the substrate having the indicia. The laminate can be a bleed laminate having an adhesive, or an over-laminate without an adhesive. Protective layer application module 410 can comprise suitable curing stations, such as UV, e-beam, IR, heat or thermal, or combinations thereof to cure a curable adhesive of the laminate if present, or the protective coating if present. In one embodiment of the invention, the indicia comprises barcodes, and after lamination, the barcodes maintain a print quality grade of “C” or better per ANSI X3.182. If one or more of the barcodes fail, the sheet is discarded at that point.

At converting module, each sheet is converted into a plurality of cards, or other articles, by punching or cutting, each card having its machine- and/or human-readable indicia imaged thereon. Cards can be cut by any of a variety of methods, including, but not limited to, a male/female punch die, a PMC (Printing Machinery Corp.) or high die, steel rule die cut, a digital cutting table, or laser.

System 400 can comprise other optional modules that are not shown, including modules for applying embellishments such as foils, glow-in-the-dark inks, lens arrays, magnetic stripes, scratch-off coatings or labels, or any of a variety of embellishments.

### Example

A plurality of cards were produced using a sheet substrate comprising a 28″×40″ 26 mil white opaque polyvinyl chloride material of gloss/matte finish is imaged with a barcode on a first gloss surface using a DOD imaging line capable of imaging a large sheet format and capable of producing a print quality grade of “C” or better per ANSI X3.182, and black UV-curable ink at a frequency of one barcode per card, each barcode having a width of 1.187″. The sheets were then compression laminated using heat and pressure over the surface having the barcode. Pixel shaving was performed on the cards from zero to fifteen percent. The barcodes were measured using an Integra Barcode Quality Station model #9500 manufactured by Label Vision Systems, Inc.

Table 1 lists the measurements before lamination, and Table 2 lists the measurements after lamination. It was found that the greater the pixel shaving, the less the degradation of the barcode after lamination. All cards maintained a “C” or better grading both before and after lamination.

TABLE 1
Print quality measurements before lamination

| | No Pixel Shaving | | | | | | 5% Pixel Shaving | | | | | |
|---|---|---|---|---|---|---|---|---|---|---|---|---|
| | NDV 0, 1, 2 | | | NDV 0, 1, 2, 3 | | | NDV 0, 1, 2 | | | NDV 0, 1, 2, 3 | | |
| Symbology | Code 128 | | | Code 128 | | | Code 128 | | | Code 128 | | |
| Decode text | L910000018193 | | | L910000018193 | | | L910000018193 | | | L910000018193 | | |
| Overall grade | 3.2 | A | | 3.5 | A | | 3.4 | B | | 3.7 | A | |
| Xdim | 9.7 mils | | | 9.7 mils | | | 9.8 mils | | | 9.7 mils | | |
| Edge determ | Pass | | | Pass | | | Pass | | | Pass | | |
| Min Refect | Pass | | | Pass | | | Pass | | | Pass | | |
| Minimum EC | Pass | | 51% | Pass | | 52% | Pass | | 52% | Pass | | 53% |
| Decode | Pass | 86 | | Pass | 91 | | Pass | 89 | | Pass | 89 | |
| Quiet zone | Pass | | | Pass | | | Pass | | | Pass | | |
| Contrast | 3.9 | A | 76% | 3.8 | A | 74% | 3.9 | A | 76% | 3.8 | A | 74% |
| Modulation | 3.2 | B | 67% | 3.5 | A | 70% | 3.4 | B | 69% | 3.7 | A | 72% |
| Decodability | 3.5 | A | 62% | 4.0 | A | 73% | 3.4 | B | 61% | 3.8 | A | 66% |
| Defects | 4.0 | A | 5% | 4.0 | A | 6% | 4.0 | A | 5% | 4.0 | A | 7% |
| Blemish | 4.0 | A | 0% | 4.0 | A | 0% | 4.0 | A | 0% | 4.0 | A | 0% |
| Rmin | | | 1% | | | 4% | | | 2% | | | 4% |
| Rmax | | | 77% | | | 77% | | | 77% | | | 77% |
| GT | | | 40% | | | 40% | | | 40% | | | 40% |
| Bar height | 0.251 | | | 0.266 | | | 0.260 | | | 0.260 | | |
| | 10% Pixel Shaving | | | | | | 15% Pixel Shaving | | | | | |
| | NDV 0, 1, 2 | | | NDV 0, 1, 2, 3 | | | NDV 0, 1, 2 | | | NDV 0, 1, 2, 3 | | |
| Symbology | Code 128 | | | Code 128 | | | Code 128 | | | Code 128 | | |
| Decode text | L910000018193 | | | L910000018193 | | | L910000018193 | | | L910000018193 | | |
| Overall grade | 3.6 | A | | 3.7 | A | | 3.9 | A | | 3.8 | A | |
| Xdim | 9.7 mils | | | 9.7 mils | | | 9.7 mils | | | 9.7 mils | | |
| Edge determ | Pass | | | Pass | | | Pass | | | Pass | | |
| Min Refect | Pass | | | Pass | | | Pass | | | Pass | | |
| Minimum EC | Pass | | 56% | Pass | | 53% | Pass | | 57% | Pass | | 55% |
| Decode | Pass | 86 | | Pass | 82 | | Pass | 89 | | Pass | 82 | |
| Quiet zone | Pass | | | Pass | | | Pass | | | Pass | | |
| Contrast | 3.9 | A | 76% | 3.8 | A | 74% | 3.9 | A | 76% | 3.8 | A | 74% |
| Modulation | 3.6 | A | 71% | 3.7 | A | 72% | 4.0 | A | 75% | 4.0 | A | 75% |
| Decodability | 3.8 | A | 66% | 4.0 | A | 74% | 4.0 | A | 74% | 4.0 | A | 75% |
| Defects | 4.0 | A | 5% | 4.0 | A | 6% | 4.0 | A | 5% | 4.0 | A | 6% |
| Blemish | 4.0 | A | 0% | 4.0 | A | 2% | 4.0 | A | 0% | 4.0 | A | 0% |
| Rmin | | | 2% | | | 4% | | | 1% | | | 3% |
| Rmax | | | 77% | | | 77% | | | 78% | | | 77% |
| GT | | | 39% | | | 40% | | | 40% | | | 40% |
| Bar height | 2.510 | | | 0.245 | | | 0.260 | | | 0.239 | | |

TABLE 2
Print Quality Measurements After Lamination

| | No Pixel Shaving | | | | | | 5% Pixel Shaving | | | | | |
|---|---|---|---|---|---|---|---|---|---|---|---|---|
| | NDV 0, 1, 2 | | | NDV 0, 1, 2, 3 | | | NDV 0, 1, 2 | | | NDV 0, 1, 2, 3 | | |
| Symbology | Code 128 | | | Code 128 | | | Code 128 | | | Code 128 | | |
| Decode text | L910000018193 | | | L910000018193 | | | L910000018193 | | | L910000018193 | | |
| Overall grade | 2.0 | C | | 2.2 | C | | 2.0 | C | | 2.2 | C | |
| Xdim | 9.7 mils | | | 9.7 mils | | | 9.7 mils | | | 9.7 mils | | |
| Edge determ | Pass | | | Pass | | | Pass | | | Pass | | |
| Min Refect | Pass | | | Pass | | | Pass | | | Pass | | |
| Minimum EC | Pass | | 41% | Pass | | 41% | Pass | | 41% | Pass | | 42% |
| Decode | Pass | 91 | | Pass | 92 | | Pass | 90 | | Pass | 89 | |
| Quiet zone | Pass | | | Pass | | | Pass | | | Pass | | |
| Contrast | 3.8 | A | 74% | 3.6 | A | 71% | 3.8 | A | 75% | 3.6 | A | 71% |
| Modulation | 2.0 | C | 55% | 2.2 | C | 57% | 2.0 | C | 55% | 2.3 | C | 58% |
| Decodability | 3.6 | A | 63% | 4.0 | A | 70% | 3.4 | B | 61% | 3.5 | A | 62% |
| Defects | 4.0 | A | 6% | 4.0 | A | 8% | 4.0 | A | 6% | 4.0 | A | 7% |
| Blemish | 4.0 | A | 0% | 4.0 | A | 0% | 4.0 | A | 0% | 4.0 | A | 0% |
| Rmin | | | 2% | | | 4% | | | 2% | | | 4% |
| Rmax | | | 77% | | | 75% | | | 76% | | | 75% |
| GT | | | 39% | | | 40% | | | 39% | | | 40% |
| Bar height | 0.266 | | | 0.269 | | | 0.266 | | | 0.260 | | |
| Bar growth | | | 4% | | | 0% | | | 2% | | | −2% |
| | 10% Pixel Shaving | | | | | | 15% Pixel Shaving | | | | | |
| | NDV 0, 1, 2 | | | NDV 0, 1, 2, 3 | | | NDV 0, 1, 2 | | | NDV 0, 1, 2, 3 | | |
| Symbology | Code 128 | | | Code 128 | | | Code 128 | | | Code 128 | | |
| Decode text | L910000018193 | | | L910000018193 | | | L910000018193 | | | L910000018193 | | |
| Overall grade | 2.3 | C | | 2.4 | C | | 2.6 | B | | 2.6 | B | |
| Xdim | 9.7 mils | | | 9.7 mils | | | 9.7 mils | | | 9.7 mils | | |
| Edge determ | Pass | | | Pass | | | Pass | | | Pass | | |
| Min Refect | Pass | | | Pass | | | Pass | | | Pass | | |
| Minimum EC | Pass | | 43% | Pass | | 42% | Pass | | 45% | Pass | | 44% |
| Decode | Pass | 93 | | Pass | 91 | | Pass | 91 | | Pass | 88 | |
| Quiet zone | Pass | | | Pass | | | Pass | | | Pass | | |
| Contrast | 3.8 | A | 74% | 3.6 | A | 72% | 3.8 | A | 74% | 3.6 | A | 72% |
| Modulation | 2.3 | C | 58% | 2.4 | C | 59% | 2.6 | B | 61% | 2.6 | B | 61% |
| Decodability | 3.5 | A | 62% | 4.0 | A | 72% | 3.9 | A | 67% | 4.0 | A | 68% |
| Defects | 4.0 | A | 5% | 4.0 | A | 6% | 4.0 | A | 6% | 4.0 | A | 6% |
| Blemish | 4.0 | A | 0% | 4.0 | A | 1% | 4.0 | A | 0% | 4.0 | A | 0% |
| Rmin | | | 2% | | | 4% | | | 2% | | | 4% |
| Rmax | | | 76% | | | 76% | | | 77% | | | 76% |
| GT | | | 39% | | | 40% | | | 40% | | | 40% |
| Bar height | 0.271 | | | 0.269 | | | 0.266 | | | 0.257 | | |
| Bar growth | | | −1% | | | −5% | | | −3% | | | −7% |

The invention may be embodied in other specific forms without departing from the essential attributes thereof; therefore, the illustrated embodiments should be considered in all respects as illustrative and not restrictive.

What is claimed is:

1. An article having a barcode imaged under a protective layer for protection of barcode, the article comprising:
a substrate presenting a first surface and a second surface, at least one of the first surface or second surface having a barcode applied thereon, wherein the substrate comprises a polymeric material selected from the group of polyvinyl chloride (PVC), polyethylene terephthalate (PETG), polylactic acid (PLA), polypropylene, polyethylene, high integrity polystyrene (HIPS), or combinations thereof; and
a protective layer covering the barcode,
wherein the barcode has a print quality grade of at least “C” or better when read through the protective layer.

2. The article of claim 1, wherein the protective layer comprises a laminate of about one to about four mils.

3. The article of claim 2, wherein the laminate comprises a poly-laminate comprising PVC, polyethylene, polypropylene, or combinations thereof.

4. The article of claim 3, wherein the laminate further comprises an adhesive for bonding the laminate to the substrate to cover the barcode.

5. The article of claim 1, wherein the protective layer comprises an optically clear coating material.

6. The article of claim 5, wherein the transparent coating material comprises a radiation curable or heat curable coating.

7. The article of claim 1, wherein the protective layer comprises a tamper-proof or tamper-evident layer that forms a destructive bond with the barcode such that upon removal of the protective layer, the barcode is no longer readable.

8. The article of claim 7, wherein the barcode comprises a 1-D barcode, a 2D barcode, or combinations thereof.

9. The article of claim 1, wherein the article comprises a transaction card, stored-value card, trading card, loyalty card, or identification/information card.

10. The article of claim 9, wherein the article comprises a transaction card having a total thickness of about 30 mils plus or minus ten percent.

11. An article having a barcode imaged under a protective layer for protection of the barcode, the article comprising:
a single core substrate presenting a first surface and a second surface, at least one of the first surface or second surface having a DOD-imaged barcode thereon, wherein the substrate comprises a polymeric material selected from the group of polyvinyl chloride (PVC), polyethylene terephthalate (PETG), polylactic acid (PLA), polypropylene, polyethylene, high integrity polystyrene (HIPS), or combinations thereof, and wherein a thickness of the substrate is about 22 to about 40 mils; and
a protective layer covering the barcode,
wherein the barcode has a print quality grade of at least “C” or better when read through the protective layer.

12. The article of claim 11, wherein the protective layer comprises a laminate of about one to about four mils.

13. The article of claim 12, wherein the laminate comprises a poly-laminate comprising PVC, polyethylene, polypropylene, or combinations thereof.

14. The article of claim 13, wherein the laminate further comprises an adhesive for bonding the laminate to the substrate to cover the barcode.

15. The article of claim 11, wherein the protective layer comprises an optically clear coating material.

16. The article of claim 15, wherein the transparent coating material comprises a radiation curable or heat curable coating.

17. The article of claim 1, wherein the protective layer comprises a tamper-proof or tamper-evident layer that forms a destructive bond with the barcode such that upon removal of the protective layer, the barcode is no longer readable.

18. The article of claim 17, wherein the barcode comprises a 1-D barcode, a 2D barcode, or combinations thereof.

19. The article of claim 11, wherein the article comprises a transaction card, stored-value card, trading card, loyalty card, or identification/information card.

20. The article of claim 19, wherein the article comprises a transaction card having a total thickness of about 30 mils plus or minus ten percent.

21. A method of producing an article having a barcode imaged under a protective layer for protection of the barcode, the article comprising:
providing a substrate sheet, wherein a first and second side of the sheet each comprise an area of about 28 inches by 40 inches or less,
imaging, by drop-on-demand, a plurality of barcodes on one or both sides of the substrate sheet;
applying a protective layer over each of the plurality of barcodes; and
verifying that each of the plurality of barcodes has a print quality of “C” or better.

22. The method of claim 21, wherein the substrate sheet comprises a polymeric material selected from the group of polyvinyl chloride (PVC), polyethylene terephthalate (PETG), polylactic acid (PLA), polypropylene, polyethylene, high integrity polystyrene (HIPS), or combinations thereof.

23. The method of claim 21, wherein the protective layer comprises a laminate of about one to about four mils.

24. The method of claim 23, wherein the laminate comprises a poly-laminate comprising PVC, polyethylene, polypropylene, or combinations thereof.

25. The method of claim 21, wherein the protective layer comprises an optically clear coating material.

26. The method of claim 21, wherein the protective layer comprises a tamper-proof or tamper-evident layer that forms a destructive bond with the barcode such that upon removal of the protective layer, the barcode is no longer readable.

27. The method of claim 21, wherein the barcode comprises a 1-D barcode, a 2D barcode, or combinations thereof.

28. The method of claim 22, the method comprising:
converting the substrate sheet into a plurality of cards, each card having a barcode from the plurality of barcodes thereon, and wherein a total thickness of each card is about 30 mils plus or minus ten percent.

29. An article having a barcode imaged under a protective layer, the article comprising:
a single core substrate presenting a first surface and a second surface, at least one of the first surface or second surface having the barcode applied thereon, the substrate comprising a polymeric material selected from the group of polyvinyl chloride (PVC), polyethylene terephthalate (PETG), polylactic acid (PLA), polypropylene, polyethylene, high integrity polystyrene (HIPS), or combinations thereof; and
a protective layer covering the barcode, wherein the article is produced by—
providing a single core substrate sheet, a first and second side of the substrate sheet having an area of about 28 inches by about 36 inches to about 28 inches by about 40 inches,
imaging a plurality of barcodes, by drop-on-demand, on one or both sides of the substrate sheet using UV curable ink,
curing the ink, wherein each of the barcodes has a print grade quality of about “B” or better,
compression laminating the protective layer to the substrate sheet such that the protective layer is covering the barcode, and
converting the substrate sheet into a plurality of articles, each article having one of the imaged barcodes thereon,
wherein the barcode has a print quality grade of at least “C” or better when read through the protective layer.
